(19) United States
(12) Patent Application Publication
(10) Pub. No.: US 2009/0097679 A1
(43) Pub. Date: Apr. 16, 2009

(54) Acoustic system for providing individual acoustic environment

(75) Inventor: Masanobu Maeda, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/285,521

(22) Filed: Oct. 8, 2008

(30) Foreign Application Priority Data
Oct. 15, 2007 (JP) 2007-268182

(51) Int. Cl. H04R 5/02

(52) U.S. Cl. 381/302

(57) ABSTRACT

To provide an acoustic system including: a sound-leakage reducing unit that generates control sound for negating sound leaked from another speaker in a second individual space to a first individual space based on a leak sound transfer function and an error path transfer function to provide the control sound; a virtual sound-source unit that generates a virtual sound source to form a sound image in front of a listener; a localization correcting unit that corrects rearward localization of the sound image formed by reproduction of the virtual sound source closer to the listener; and a dynamic presuming unit that provides the leak sound transfer function and the error path transfer function to the sound-leakage reducing unit, and provides the error path transfer function to the localization correcting unit.

### CROSS-REFERENCE TO RELATED APPLICATIONS

The present application claims priority to and incorporates by reference the entire contents of Japanese priority document 2007-268182 filed in Japan on Oct. 15, 2007.

### BACKGROUND OF THE INVENTION

1. Field of the Invention

The present invention relates to an acoustic system for providing an individual acoustic environment with respect to each individual space in a predetermined space, and, more particularly to an acoustic system that can effectively reduce sound leakage from other seats even if there is an environmental change or a change with time, and that can provide an individual acoustic environment with a realistic sense while not blocking visibility of a listener.

2. Description of the Related Art

An acoustic system for providing a different acoustic environment for each seat has been known in vehicles such as airplanes, trains, and cars. However, if a listener does not use a headset, leak sound or noise from other seats causes a problem. Therefore, to provide a comfortable individual acoustic environment, reduction of such noise is important.

For example, Patent Document 1 (Japanese Patent Application Laid-open No. H5-61477) discloses a method of reducing noise by using an error microphone for obtaining noise to generate a control sound for negating the obtained noise. Further, as a method of reducing sound leakage from other seats, Filtered-XLMS (adaptive least mean square filter) that uses an output of an error microphone and an other-seat sound source as a reference signal has been known.

It is assumed here that an other-seat speaker is arranged on other seats and a self seat speaker and a self-seat error microphone are arranged on a self seat. When the Filtered-XLMS is used, a control sound for negating sound leakage is generated based on a leak sound transfer function from the other-seat speaker to the self seat and an error path transfer function between the self seat speaker and the self-seat error microphone. As such an error path transfer function, a function that is presumed in advance prior to provision of the acoustic system is generally used.

However, when the error path transfer function presumed in advance is used, there is a problem that, when a sound field environment is changed between the time of presumption and the time of control, reduction accuracy of the leak sound deteriorates. Specifically, there is a change in the sound field environment (an environmental change such as person's position, humidity, and temperature, and a change with time of the error microphone and the speaker), between the time of presumption of the error path transfer function and the time of control using such an error path transfer function. However, because the path transfer function used at the time of control is not for the sound field environment at the time of control, highly accurate sound-leakage reduction control cannot be performed.

Meanwhile, to improve the control efficiency of the sound-leakage reduction control, it is desired to install a speaker and an error microphone at a position close to ears of a listener. However, when an individual acoustic environment is provided in a car, the speaker and the error microphone need to be installed on a self seat due to a safety reason such as not blocking the visibility of a driver.

However, if the speaker is installed on the self seat, the listener hears the sound from the back, thereby causing a problem such that a sound image is localized at the back, and listening with a realistic sense becomes difficult.

Accordingly, in the case that a speaker is arranged at the back of a listener, it is an important issue how to realize an acoustic system that can effectively reduce sound leakage from other seats even if there is an environmental change or a change with time, and that can provide an individual acoustic environment with a realistic sense while not blocking visibility of a listener.

### SUMMARY OF THE INVENTION

It is an object of the present invention to at least partially solve the problems in the conventional technology.

According to the present invention, an acoustic system includes: a self speaker that is installed to be located at back of a listener in a first individual space in a predetermined space; an error microphone that is installed to be located closer to the listener than the self speaker; a sound-leakage reducing unit that generates control sound for negating sound leaked from an other speaker installed in a second individual space in the predetermined space to the first individual space based on a leak sound transfer function between the other speaker and the error microphone and an error path transfer function between the self speaker and the error microphone, and provides the control sound to the self speaker; a virtual sound-source unit that generates a virtual sound source to form a sound image in front of the listener; a localization correcting unit that corrects rearward localization of the sound image closer to the listener, the sound image being formed by reproduction of the virtual sound source by the self speaker; and a dynamic presuming unit that is connected to the error microphone, the sound-leakage reducing unit, and the localization correcting unit, provides the leak sound transfer function and the error path transfer function presumed dynamically to the sound-leakage reducing unit, and provides the error path transfer function presumed dynamically to the localization correcting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a configuration of an acoustic system according to a first embodiment;

FIG. 2 is a diagram of an individual acoustic environment in a car;

FIG. 3 is a diagram illustrating the effects of a virtual sound-source filter and a rear-sound-source inverse filter;

FIG. 4 is a schematic diagram of a configuration of the acoustic system of the first embodiment applied to a plurality of seats;

FIG. 5 is a diagram of a signal flow in the acoustic system according to the first embodiment;

FIG. 6 is a schematic diagram of a configuration of an acoustic system according to a second embodiment;

FIG. 7 is a schematic diagram of a configuration of the acoustic system of the second embodiment applied to a plurality of seats;

FIG. 8 is a diagram of a signal flow in the acoustic system according to the second embodiment;

FIG. 9 is a diagram illustrating a switching process of localization control and sound-leakage reduction control; and

FIG. 10 is a schematic diagram of a configuration of an acoustic system according to a conventional technology.

### DETAILED DESCRIPTION

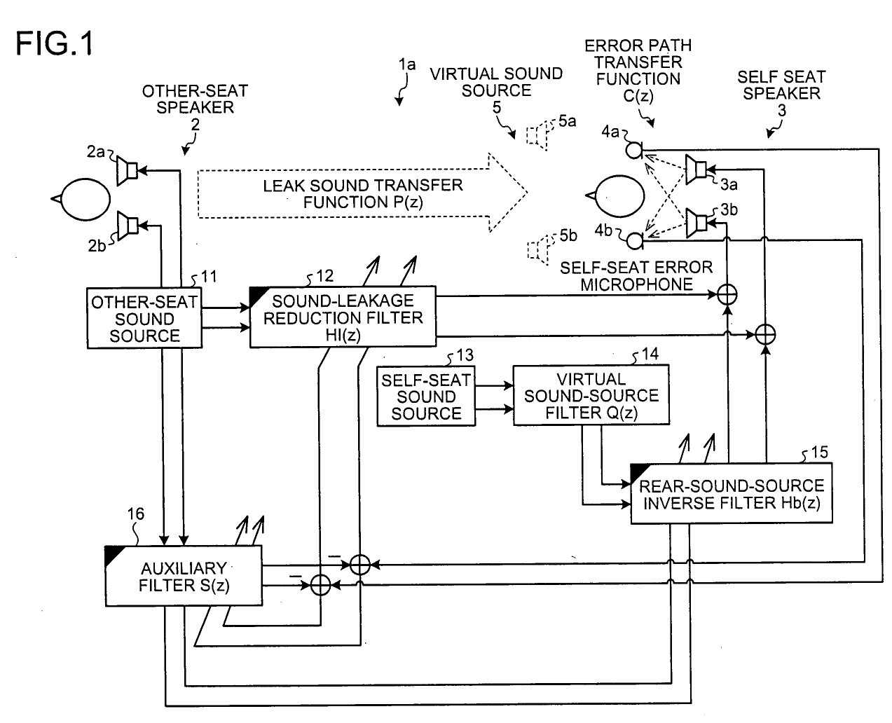

FIG. 1 is a schematic diagram of a configuration of an acoustic system according to a first embodiment. The first embodiment describes the case where a sound-leakage reduction filter and a rear-sound-source inverse filter are adaptively controlled by an auxiliary filter connected to an other-seat sound source side. A second embodiment describes the case where the sound-leakage reduction filter and the rear-sound-source inverse filter are adaptively controlled by an auxiliary filter connected to a self-seat sound source side is explained. While the acoustic system according to the present invention is explained below as being applied to a car, it can also be applied to seats in movie theaters and concert halls.

As illustrated in FIG. 1, an acoustic system 1a includes an other-seat speaker 2, a self seat speaker 3, a self-seat error microphone 4, an other-seat sound source 11, a sound-leakage reduction filter 12, a self-seat sound source 13, a virtual sound-source filter 14, a rear-sound-source inverse filter 15, and an auxiliary filter 16. The sound provided from the self seat speaker 3 has a virtual sound image in front of a listener on a self seat (see “virtual sound source 5” in FIG. 1). Filters indicated in black at an upper left corner (the sound-leakage reduction filter 12 and the auxiliary filter 16) express that these filters are ADFs (adaptive digital filters).

As illustrated in FIG. 1, the acoustic system 1a according to the first embodiment dynamically presumes a leak sound transfer function P(z) between the other-seat speaker 2 and the self-seat error microphone 4 and an error path transfer function C(z) between the self seat speaker 3 and the self-seat error microphone 4 to effectively reduce the sound leaked from the other-seat speaker 2 to the listener on the self seat, and localizes the sound generated from the self seat speaker 3 in front of the listener as indicated by the virtual sound source 5 to provide an individual acoustic environment with a realistic sense.

Thus, by providing the leak sound transfer function P(z) and the error path transfer function C(z) presumed dynamically by the auxiliary filter 16 to the sound-leakage reduction filter 12, and providing the error path transfer function C(z) presumed dynamically to the rear-sound-source inverse filter 15, the accuracy of the sound-leakage reduction filter 12 and the rear-sound-source inverse filter 15 can be improved. Because the sound-leakage reduction filter 12 and the rear-sound-source inverse filter 15 are adaptively controlled by using one auxiliary filter (the auxiliary filter 16), a calculation amount can be reduced as compared with a case that a plurality of auxiliary filters are used.

Further, by generating a sound having a sound image in front of the listener by the virtual sound-source filter 14, and localizing the sound image with the position of the self seat speaker 3 being set as a reference at a position of the self-seat error microphone 4 near the ear position of the listener by the rear-sound-source inverse filter 15, the individual acoustic environment with a realistic sense can be provided.

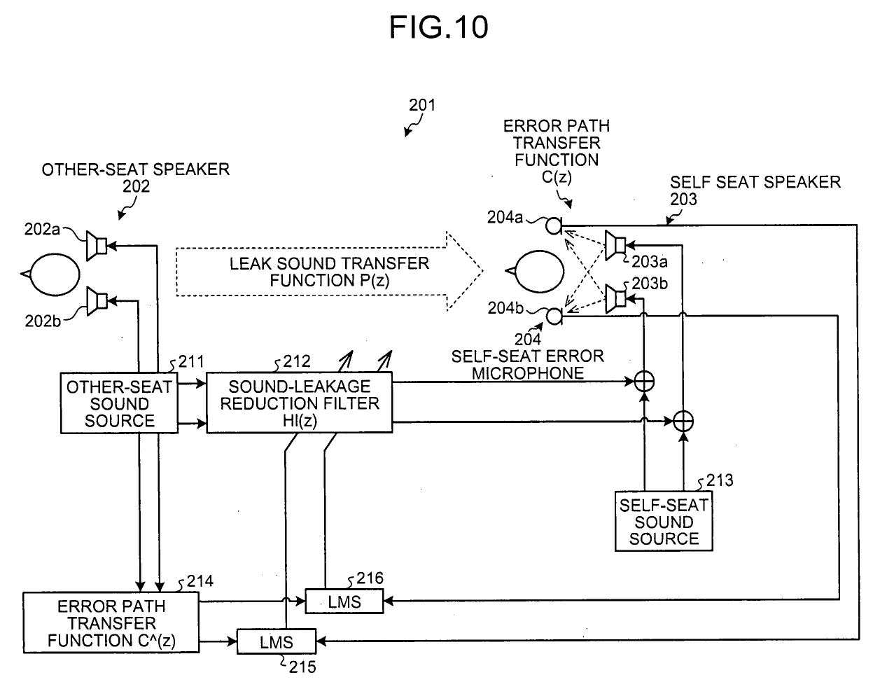

A conventional acoustic system is explained with reference to FIG. 10 from a viewpoint of clarifying a characteristic feature of the acoustic system 1a according to the first embodiment. FIG. 10 is a schematic diagram of a configuration of an acoustic system 201 according to the conventional technology.

As illustrated in FIG. 10, the acoustic system 201 according to the conventional technology includes an other-seat speaker 202, a self seat speaker 203, a self-seat error microphone 204, an other-seat sound source 211, a sound-leakage reduction filter 212, a self-seat sound source 213, an error path transfer function 214, an LMS (least mean square filter) 215 and an LMS 216. The LMS 215 and LMS 216 respectively correspond to left and right self-seat error microphones (204a and 204b), and a filter indicated in black at an upper left corner (the sound-leakage reduction filter 12) expresses that the filter is the ADF (adaptive digital filter).

As illustrated in FIG. 10, the transfer function between the other-seat speaker 202 and the self-seat error microphone 204 is defined as “leak sound transfer function P(z)” and a transfer function between the self seat speaker 203 and the self-seat error microphone 204 is defined as “error path transfer function C(z)”. An entity of the error path transfer function 214 is “error path transfer function Ĉ(z)”, in which the “error path transfer function C(z)” is presumed in advance.

That is, the acoustic system 201 according to the conventional technology adaptively controls the sound-leakage reduction filter 212 based on the “error path transfer function Ĉ(z)” presumed in advance and an output of the self-seat error microphone 204. The sound-leakage reduction filter 212 presumes the “leak sound transfer function P(z)” based on the static “error path transfer function Ĉ(z)”.

However, because the “error path transfer function C(z)” changes according to a sound field environment (environment such as person's position, humidity, and temperature, and environment with time of the error microphone and the speaker) at the time of control, the “error path transfer function C(z)” is separated from a static “error path transfer function Ĉ(z)”. Therefore, even if the sound-leakage reduction filter 212 is adaptively controlled by using the error path transfer function 214, with the “error path transfer function Ĉ(z)” being the entity, highly accurate reduction of sound leakage cannot be performed.

In the acoustic system 201 according to the conventional technology, because the self seat speaker 203 installed at the back of the listener on the self seat provides the acoustic environment to the listener on the self seat, the acoustic environment to be provided is localized at the back of the listener. Therefore, there is a problem that an acoustic environment with a realistic sense cannot be provided to the listener.

In the acoustic system 1 according to the first embodiment illustrated in FIG. 1, therefore, the sound-leakage reduction filter 12 and the rear-sound-source inverse filter 15 are adaptively controlled by using the auxiliary filter 16 that dynamically presumes the “error path transfer function C(z)” and the “leak sound transfer function P(z)”, and the sound image is localized in front of the listener by using the virtual sound-source filter 14 and the rear-sound-source inverse filter 15.

Returning to the explanation of FIG. 1, the acoustic system 1 according to the first embodiment is explained in detail. The other-seat speaker 2 includes a right speaker 2a and a left speaker 2b, and is installed, for example, on a backside of a driver's seat or the like in the car. The other-seat speaker 2 is connected to the other-seat sound source 11, and reproduces the individual acoustic environment such as music and voices for other seats.

The self seat speaker 3 includes a right speaker 3a and a left speaker 3b, and is installed, for example, on a backside of a rear seat in the car. The self seat speaker 3 is connected to the sound-leakage reduction filter 12 and the rear-sound-source inverse filter 15, to reproduce the individual acoustic environment such as music or voices for the self seat, and reproduce a control sound for negating the leak sound from the other-seat speaker 2.

The self-seat error microphone 4 includes a right error microphone 4a and a left error microphone 4b respectively installed in front of the right speaker 3a and the left speaker 3b constituting the self seat speaker 3. The self-seat error microphone 4 is installed, for example, on the backside of the rear seat in the car as in the case of the self seat speaker 3. An output of the self-seat error microphone 4 is used for presumption of each transfer function in the auxiliary filter 16.

The other-seat sound source 11 is a device that reproduces music or voices recorded on a portable recording medium such as a CD (compact disk) or a DVD (digital versatile disk), or music or voice from radio, television, car navigation system and the like. An output of the other-seat sound source 11 is input to the other-seat speaker 2 and also to the auxiliary filter 16.

The sound-leakage reduction filter 12 uses the leak sound transfer function P(z) and the error path transfer function C(z) presumed based on the output of the auxiliary filter 16, to generate a control sound for negating the leak sound from the other-seat speaker 2 on the front seat. The sound-leakage reduction filter 12 is configured as the ADF (adaptive digital filter).

A calculation procedure performed by the sound-leakage reduction filter 12 is briefly explained. When it is assumed that the sound-leakage reduction filter 12 is “Hl(z)”, the auxiliary filter 16 is “S(z)”, the leak sound transfer function is “P(z)”, and error path transfer function is “C(z)”, relation between these is expressed by an equation “S(z)=P(z)+Hl(z)C(z)”. The control sound (negating sound) generated by the sound-leakage reduction filter 12 is expressed as “Hl(z)C(z)”.

In the equation “S(z)=P(z)+Hl(z)C(z)”, by inputting two initial values (S1(z), Hl1(z), and S2(z), Hl2(z)) respectively to S(z) and Hl(z), and updating S(z) and Hl(z) so that a negating error becomes minimum, optimum P(z) and C(z) can be presumed. An optimum Hl(z) is expressed by an equation “Hl(z)=−P(z)/C(z)”.

The self-seat sound source 13 is a device that reproduces music or voice recorded on a portable recording medium such as a CD (compact disk) or a DVD (digital versatile disk), or music or voice from radio, television, car navigation system and the like. An output of the self-seat sound source 13 is output to the self seat speaker 3 via the virtual sound-source filter 14 and the rear-sound-source inverse filter 15.

The virtual sound-source filter 14 is a filter (Q(z)) that receives the output from the self-seat sound source 13 to generate a virtual sound field having a virtual sound image in front of the listener on the self seat. The virtual sound field generated by the virtual sound-source filter 14 is obtained, as indicated by the virtual sound source 5 in FIG. 1, by processing a signal from the self-seat sound source 13 as if there is a sound source in front of the listener. The virtual sound-source filter 14 can obtain a sound field with a realistic sense and without exerting a processing load, because the transfer function is obtained in advance based on a preliminary measurement result.

The rear-sound-source inverse filter 15 is a filter corresponding to an inverse function of the error path transfer function C(z) between the self seat speaker 3 and the self-seat error microphone 4, and performs a process of localizing the virtual sound field based on the position of the self seat speaker 3 at a position of the self-seat error microphone 4. Accordingly, rearward localization of the sound image resulting from installation of the self seat speaker 3 at the back of the listener can be corrected. When the rear-sound-source inverse filter 15 is designated as “Hb(z)”, Hb(z) is expressed by an equation “Hb(z)=1/C(z)”. The C(z) in this equation is dynamically presumed by the auxiliary filter 16.

The auxiliary filter 16 receives the outputs from the other-seat sound source 11 and the self-seat error microphone 4, and performs a process of presuming the leak sound transfer function P(z) and the error path transfer function C(z). An output of the auxiliary filter 16 is used for adaptive control of the sound-leakage reduction filter 12 and the rear-sound-source inverse filter 15.

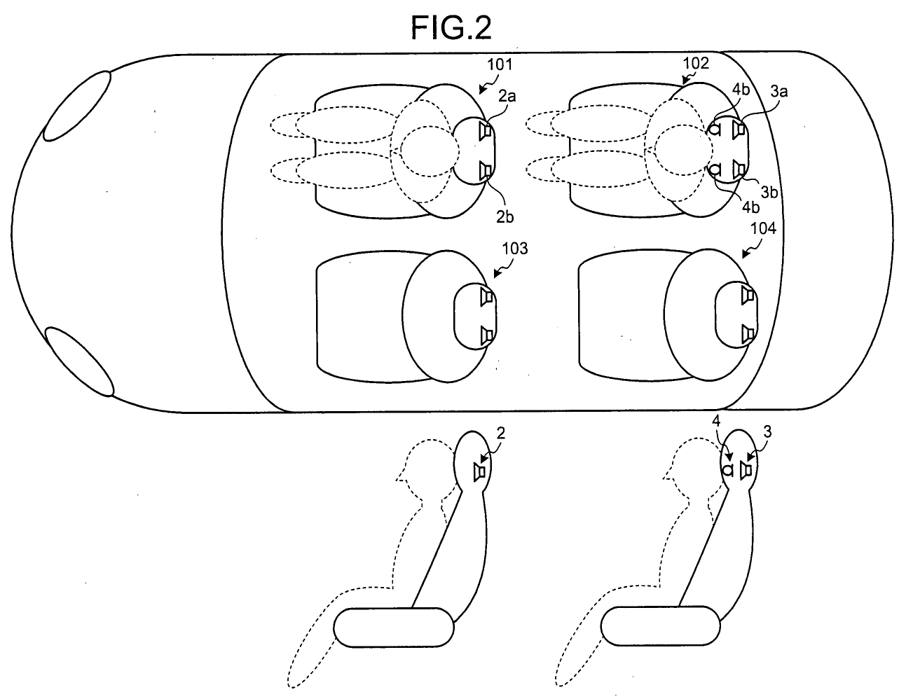

A positional relation of the other-seat speaker 2, the self seat speaker 3, and the self-seat error microphone 4 explained with reference to FIG. 1 is explained with reference to FIG. 2. FIG. 2 depicts an individual acoustic environment in the car. As illustrated in FIG. 2, the speaker is installed in each seat in the car, to provide the acoustic environment different from each other, that is, an individual acoustic environment to each individual space corresponding to each seat. FIG. 2 depicts a case that a rear seat 102 at the back of the driver's seat is designated as the “self seat”, and a driver's seat 101 is designated as an “other seat”, and the individual acoustic environment provided for the rear seat 102 at the back of the driver's seat is improved.

As illustrated in FIG. 1, the self seat speaker 3 including the right speaker 3a and the left speaker 3b is installed toward the listener near the head of the listener on the rear seat 102 at the back of the driver's seat. The self-seat error microphone 4 including the right error microphone 4a and the left error microphone 4b is further installed in front of the self seat speaker 3 (at a position on the listener's side on the seat).

Further, the other-seat speaker 2 including the right speaker 2a and the left speaker 2b is installed toward the listener near the head of the listener on the driver's seat 101. In FIG. 2, a case is illustrated that the rear seat 102 at the back of the driver's seat is designated as the “self seat”, and the driver's seat 101 is designated as the “other seat”. However, any of a passenger seat 103 and a rear seat 104 of the passenger seat can be designated as the “other seat”, or the “other seat” can be the respective seats (102 to 104) in combination. Further, the error microphone can be installed in each seat, thereby improving the individual acoustic environment provided to respective seats other than the driver's seat 101.

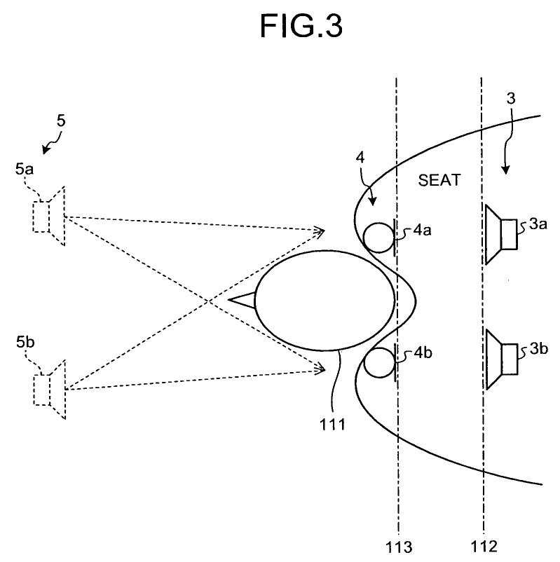

The effects of the virtual sound-source filter 14 and the rear-sound-source inverse filter 15 are explained next with reference to FIG. 3. FIG. 3 illustrates the effects of the virtual sound-source filter 14 and the rear-sound-source inverse filter 15. As illustrated in FIG. 3, the virtual sound source 5 generated by the virtual sound-source filter 14 includes a right virtual sound source 5a and a left virtual sound source 5b, and has a sound image as if the sound source is present in front of a listener 111. Therefore, an individual acoustic environment can be provided with a realistic sense compared with the case of using only the self-seat sound source 13.

However, although the virtual sound source 5 generated by the virtual sound-source filter 14 has a sound image in front of the listener 111, the virtual sound-source filter 14 does not include a transfer characteristic in a space between the self seat speaker 3 and the self-seat error microphone 4 (a space put between 112 and 113 illustrated in FIG. 3). Therefore, the reproduced sound image is localized rearward or at an obscure position.

The rear-sound-source inverse filter 15 is for correcting that a localization sense is blurred due to an influence of the space put between 112 and 113. Accordingly, the virtual sound source 5 can be listened at the position of the listener 111.

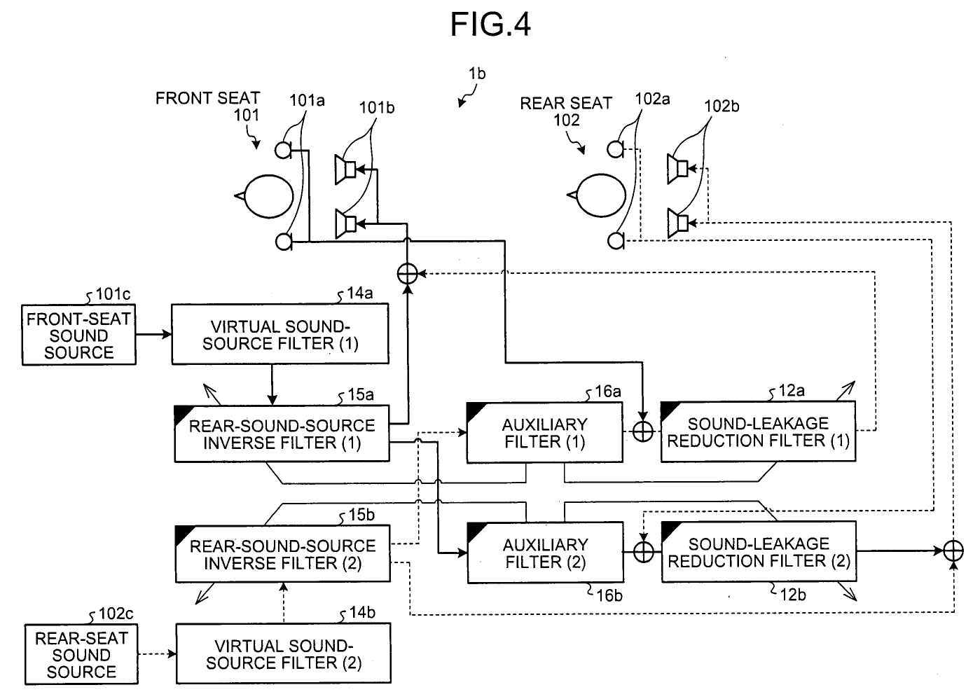

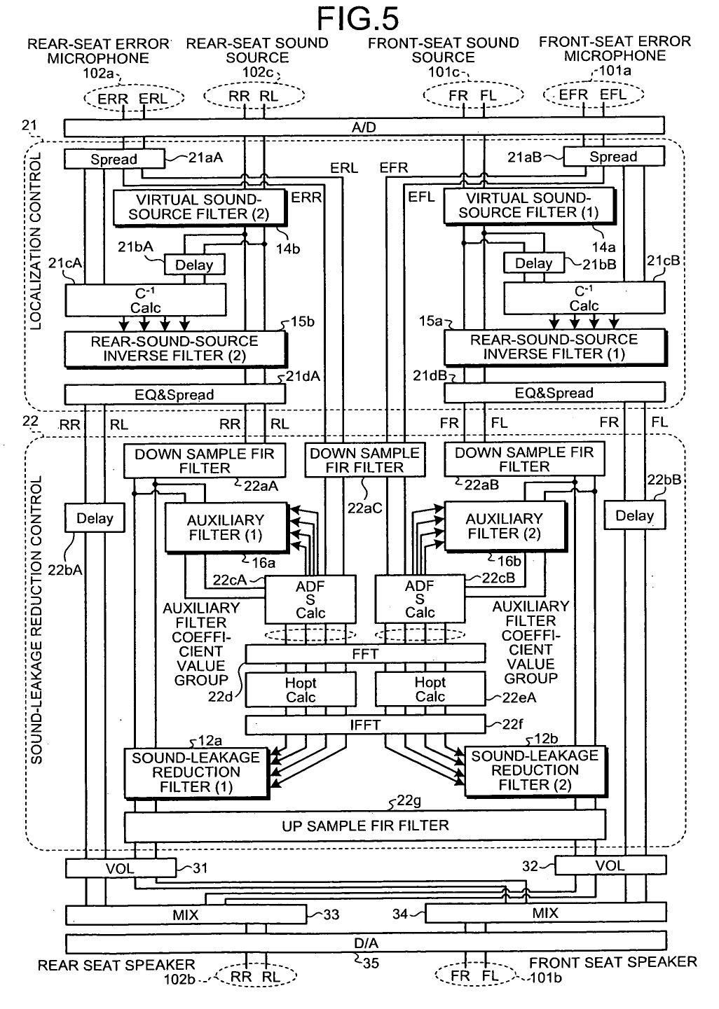

An overall configuration of an acoustic system 1b in a case that the acoustic system 1a according to the first embodiment is applied to a plurality of seats is explained with reference to FIG. 4. FIG. 4 depicts the overall configuration when the acoustic system 1a according to the first embodiment is applied to a plurality of seats. In FIG. 5, the “other seat” in FIG. 1 is referred to as a “front seat”, and the “self seat” is referred to as a “rear seat”. Further, the other-seat sound source 11 in FIG. 1 is described as a front-seat sound source 101c and the self-seat sound source 13 is described as a rear-seat sound source 102c.

As illustrated in FIG. 4, the acoustic system 1b includes two sets of the sound-leakage reduction filter 12, the virtual sound-source filter 14, the rear-sound-source inverse filter 15, and the auxiliary filter 16 illustrated in FIG. 1. A front-seat error microphone 101a and a front seat speaker 101b are provided to the front seat 101, and a rear-seat error microphone 102a and a rear seat speaker 102b are provided to the rear seat 102. The front-seat sound source 101c is prepared as a sound source corresponding to the front seat 101, and the rear-seat sound source 102c is prepared as a sound source corresponding to the rear seat 102. Further, as illustrated in FIG. 4, the error microphone and the speaker are installed at each seat.

In the acoustic system 1a illustrated in FIG. 1, because provision of the virtual sound source and localization control processing with respect to the other seat are omitted, the other-seat sound source 11 is directly connected to the other-seat speaker 2. However, in the acoustic system 1b illustrated in FIG. 4, provision of the virtual sound source and the localization control processing are performed with respect to each seat. Therefore, the front-seat sound source 101c is connected to the front seat speaker 101b via a virtual sound-source filter 14a and a rear-sound-source inverse filter 15a. Likewise, the rear-seat sound source 102c is connected to the rear seat speaker 102b via a virtual sound-source filter 14b and a rear-sound-source inverse filter 15b.

As illustrated in FIG. 4, an auxiliary filter 16a (auxiliary filter (1) in FIG. 4) adaptively controls the rear-sound-source inverse filter 15a (rear-sound-source inverse filter (1) in FIG. 4) and a sound-leakage reduction filter 12a (rear-sound-source inverse filter (1) in FIG. 4). Further, an auxiliary filter 16b (auxiliary filter (2) in FIG. 4) adaptively controls the rear-sound-source inverse filter 15b (rear-sound-source inverse filter (2) in FIG. 4) and a sound-leakage reduction filter 12b (rear-sound-source inverse filter (2) in FIG. 4).

Sound-leakage reduction control with respect to the rear seat 102 is performed in a procedure described below. That is, a signal through the front-seat sound source 101c, the virtual sound-source filter 14a, (virtual sound-source filter (1)), and the rear-sound-source inverse filter 15a (rear-sound-source inverse filter (1)) and a signal from the rear-seat error microphone 102a are input to the auxiliary filter 16b (auxiliary filter (2)). The auxiliary filter 16b (auxiliary filter (2)) dynamically presumes the error path transfer function between the rear-seat error microphone 102a and the rear seat speaker 102b, and the leak sound transfer function between the rear-seat error microphone 102a and the front seat speaker 101b, and provides the dynamically presumed error path transfer function and leak sound transfer function to the sound-leakage reduction filter 12b (sound-leakage reduction filter (2)). The sound-leakage reduction filter 12b (sound-leakage reduction filter (2)) outputs a control sound for negating a sound leaked from the front seat speaker 101b to the rear seat speaker 102b.

Localization control with respect to the rear seat 102 is performed in a procedure described below. That is, the error path transfer function dynamically presumed by the auxiliary filter 16b (auxiliary filter (2)) is provided to the rear-sound-source inverse filter 15b (rear-sound-source inverse filter (2)), and the rear-sound-source inverse filter 15b (rear-sound-source inverse filter (2)) performs a process of localizing a signal from the virtual sound-source filter 14b (virtual sound-source filter (2)) forward and outputs the signal to the rear seat speaker 102b.

On the other hand, the sound-leakage reduction control with respect to the front seat 101 is performed in a procedure described below. That is, a signal through the rear-seat sound source 102c, the virtual sound-source filter 14b (virtual sound-source filter (2)), and the rear-sound-source inverse filter 15b (rear-sound-source inverse filter (2)) and a signal from the front-seat error microphone 101a are input to the auxiliary filter 16a (auxiliary filter (1)). The auxiliary filter 16a (auxiliary filter (1)) dynamically presumes the error path transfer function between the front-seat error microphone 101a and the front seat speaker 101b, and the leak sound transfer function between the front-seat error microphone 101a and the rear seat speaker 102b, and provides the dynamically presumed error path transfer function and leak sound transfer function to the sound-leakage reduction filter 12a (sound-leakage reduction filter (1)). The sound-leakage reduction filter 12a (sound-leakage reduction filter (1)) outputs a control sound for negating a sound leaked from the rear seat speaker 102b to the front seat speaker 101b.

Further, localization control with respect to the front seat 101 is performed in a procedure described below. That is, the error path transfer function dynamically presumed by the auxiliary filter 16a (auxiliary filter (1)) is provided to the rear-sound-source inverse filter 15a (rear-sound-source inverse filter (1)), and the rear-sound-source inverse filter 15a (rear-sound-source inverse filter (1)) performs a process of localizing a signal from the virtual sound-source filter 14a (virtual sound-source filter (1)) forward and outputs the signal to the front seat speaker 101b.

A signal flow in the acoustic system 1b illustrated in FIG. 4 is explained next with reference to FIG. 5. FIG. 5 depicts a signal flow in the acoustic system 1b according to the first embodiment. In FIG. 5, “A/D 30” stands for analog-to-digital converter, “Spread 21aA” and “Spread 21aB” denote signal distributor or duplicator, “EQ and Spread 21dA” and “EQ and Spread 21aB” denote distributor and equalizer, “FFT 22d” stands for Fast Fourier Transform, “IFFT 21f” stands for inverse Fast Fourier Transform, “VOL 31” and “VOL 32” stand for volume, “MIX 33” and “MIX 34” stand for mixer, and “D/A 35” stands for digital-to-analog converter.

Further, regarding the rear-seat error microphone 102a, a right signal is described as “ERR” and a left signal is described as “ERL”, and regarding the rear seat speaker 102b, the right signal is described as “RR” and the left signal is described as “RL”. Regarding the front-seat error microphone 101a, the right signal is described as “EFR” and the left signal is described as “EFL”, and regarding the front seat speaker 101b, the right signal is described as “FR” and the left signal is described as “FL”.

As illustrated in FIG. 5, control processing performed by the acoustic system 1b can be divided into localization control 21 mainly performed by the virtual sound-source filter 14 (see 14a and 14b in FIG. 5) and the rear-sound-source inverse filter 15 (see 15a and 15b in FIG. 5), and sound-leakage reduction control 22 mainly performed by the auxiliary filter 16 (see 16a and 16b in FIG. 5) and the sound-leakage reduction filter 12 (see 12a and 12b in FIG. 5). C⁻¹ calculated by C⁻¹ Calc 21cA in the localization control 21 is an inverse function of the error path transfer function C(z) between the rear-seat error microphone 102a and the rear seat speaker 102b dynamically presumed by the auxiliary filter 16b (auxiliary filter (2)), and C⁻¹ calculated by C⁻¹ Calc 21cB is an inverse function of the error path transfer function C(z) between the front-seat error microphone 101a and the front seat speaker 101b dynamically presumed by the auxiliary filter 16a (auxiliary filter (1)).

A signal flow in the localization control 21 is explained first. The signals RR and RL corresponding to the rear-seat sound source 102c are input to the virtual sound-source filter 14b (virtual sound-source filter (2)) via the A/D 30. The virtual sound-source filter 14b (virtual sound-source filter (2)) converts the signals RR and RL to signals corresponding to the virtual sound field having a virtual sound image in front of the listener on the rear seat, and outputs the signals to the rear-sound-source inverse filter 15b (rear-sound-source inverse filter (2)) and a Delay 21bA as a delay device.

Further, the signals ERR and ERL corresponding to the rear-seat sound source 102a are input to the C⁻¹ Calc 21cA via the A/D 30 and the Spread 21aA. The C⁻¹ Calc 21cA calculates C⁻¹ based on the error path transfer function C(z) between the rear-seat error microphone 102a and the rear seat speaker 102b dynamically presumed by the auxiliary filter 16a (auxiliary filter (2)), and outputs C⁻¹ to the rear-sound-source inverse filter 15b (rear-sound-source inverse filter (2)). The rear-sound-source inverse filter 15b (rear-sound-source inverse filter (2)) outputs the signals RR and RL subjected to a correction process of bringing rearward localization of the sound image closer to the ear position of the listener to the EQ and Spread 21dA.

Meanwhile, the signals FR and FL corresponding to the front-seat sound source 101c are input to the virtual sound-source filter 14a (virtual sound-source filter (1)) via the A/D 30. The virtual sound-source filter 14a (virtual sound-source filter (1)) converts the signals FR and FL to signals corresponding to the virtual sound field having a virtual sound image in front of the listener on the front seat, and outputs the signals to the rear-sound-source inverse filter 15a (rear-sound-source inverse filter (1)) and a Delay 21bB as the delay device.

Further, the signals EFR and EFL corresponding to the front-seat error microphone 101a are input to the C⁻¹ Calc 21cB via the A/D 30 and the Spread 21aB. The C⁻¹ Calc 21cB calculates C⁻¹ based on the error path transfer function C(z) between the front-seat error microphone 101a and the front seat speaker 101b, and outputs C⁻¹ to the rear-sound-source inverse filter 15a (rear-sound-source inverse filter (1)). The rear-sound-source inverse filter 15a (rear-sound-source inverse filter (1)) outputs to the EQ and Spread 21dB the signals FR and FL having subjected to the correction process of bringing the rearward localization of the sound image closer to the ear position of the listener.

A signal flow in the sound-leakage reduction control 22 is explained next. The signals RR and RL distributed by the EQ and Spread 21dA are input to the Delay 22bA and a Down Sample FIR filter 22aA. The Delay 22bA having received the distributed signals RR and RL performs a predetermined delay process with respect to these signals, and outputs the signals to the rear-seat speaker 102b via the VOL 31, the MIX 33, and the D/A 34 as signals RR and RL.

Further, the Down Sample FIR filter 22aA having received the distributed signals RR and RL performs resampling (down-sampling) by using a sampling frequency lower than the sampling frequency of the input signals. The signals down-sampled by the Down Sample FIR filter 22aA are up-sampled in an Up Sample FIR filter 22g and output. Thus, by using the down-sampling and the up-sampling together, the leak sound can be reduced highly accurately, as compared with a case that only a sound in a predetermined frequency range is reduced by using a low-pass filter or the like.

The signals RR and RL output from the Down Sample FIR filter 22aA are input to the auxiliary filter 16a (auxiliary filter (1)) and the sound-leakage reduction filter 12a (sound-leakage reduction filter (1)). The signals RR and RL output from the auxiliary filter 16a (auxiliary filter (1)) are input to an ADF-S-Calc 22cA together with the signals ERR and ERL down-sampled by the Down Sample FIR filter 22aC, thereby calculating a value S(z) of the auxiliary filter 16a (auxiliary filter (1)) in the ADF-S-Calc 22cA.

A coefficient value group calculated by the ADF-S-Calc 22cA is then output to the sound-leakage reduction filter 12a (sound-leakage reduction filter (1)) via the FFT 22d, a Hopt Calc 22eA, and the IFFT 22f. The Hopt Calc 22eA calculates a value Hl(z) of the sound-leakage reduction filter 12a (sound-leakage reduction filter (1)).

The control sound (negating sound of the leak sound) calculated by the sound-leakage reduction filter 12a (sound-leakage reduction filter (1)) is then output to the MIX 34 via the Up Sample FIR filter 22g and the VOL 31, synthesized with the signals FR and FL converted in the localization control 21 by the MIX 34, and output to the front seat speaker 101b via the D/A 35 as the signals FR and FL.

Meanwhile, the signals FR and FL distributed by the EQ and Spread 21dB are input to a Delay 22bB and a Down Sample FIR filter 22aB. The Delay 22bB having received the distributed signals FR and FL performs a predetermined delay process with respect to these signals, and outputs the signals to the front seat speaker 101b via the VOL 32, the MIX 34, and the D/A 35 as signals FR and FL.

Further, the Down Sample FIR filter 22aB having received the distributed signals FR and FL performs resampling (down-sampling) by using a sampling frequency lower than the sampling frequency of the input signals.

The signals FR and FL output from the Down Sample FIR filter 22aB are input to the auxiliary filter 16b (auxiliary filter (2)) and the sound-leakage reduction filter 12b (sound-leakage reduction filter (2)). The signals FR and FL output from the auxiliary filter 16b (auxiliary filter (2)) are input to an ADF-S-Calc 22cB together with the signals EFR and EFL down-sampled by the Down Sample FIR filter 22aC, thereby calculating a value S(z) of the auxiliary filter 16b (auxiliary filter (2)) in the ADF-S-Calc 22cB.

A coefficient value group calculated by the ADF-S-Calc 22cB is then output to the sound-leakage reduction filter 12b (sound-leakage reduction filter (2)) via the FFT 22d, a Hopt Calc 22eB, and the IFFT 22f. The Hopt Calc 22eB calculates a value Hl(z) of the sound-leakage reduction filter 12b (sound-leakage reduction filter (2)).

The control sound (negating sound of the leak sound) calculated by the sound-leakage reduction filter 12b (sound-leakage reduction filter (2)) is then output to the MIX 33 via the Up Sample FIR filter 22g and the VOL 32, synthesized with the signals RR and RL converted in the localization control 21 by the MIX 33, and output to the rear seat speaker 102b via the D/A 35 as the signals RR and RL.

As described above, according to the first embodiment, the sound-leakage reduction filter generates a control sound for negating the sound leaked from the other speaker installed in a second individual space toward a first individual space based on the leak sound transfer function between the other speaker and the error microphone and the error path transfer function between the self speaker and the error microphone, by using the self speaker installed at the back of the listener in the first individual space and the error microphone installed closer to the listener than the self speaker, and provides the generated control sound to the self speaker. The virtual sound-source filter generates a virtual sound source, which is a sound provided by arranging a sound image in front of the listener, and the rear-sound-source inverse filter corrects the rearward localization of the sound image generated by reproduction of the virtual sound source by the self speaker closer to the listener. The auxiliary filter connected to the error microphone, the sound-leakage reduction filter, and the rear-sound-source inverse filter provides the leak sound transfer function and the error path transfer function presumed dynamically to the sound-leakage reduction filter, and the error path transfer function presumed dynamically to the rear-sound-source inverse filter. When providing the leak sound transfer function and the error path transfer function presumed dynamically to the sound-leakage reduction filter, the auxiliary filter also provides the error path transfer function to the rear-sound-source inverse filter.

Therefore, even if there is an environmental change and a change with time, leak sound from other seats can be effectively reduced, and an individual acoustic environment can be provided with a realistic sense while not blocking the visibility of the listener.

In the first embodiment, a case that the auxiliary filter connected to the other-seat sound source side adaptively controls the sound-leakage reduction filter and the rear-sound-source inverse filter has been explained; however, the connection position of the auxiliary filter can be changed. In the second embodiment explained below, therefore, a case that the auxiliary filter connected to the self-seat sound source side adaptively controls the sound-leakage reduction filter and the rear-sound-source inverse filter is explained. In the explanation of the second embodiment, as for parts of the explanation overlapping with the first embodiment, they will be omitted or explained only briefly.

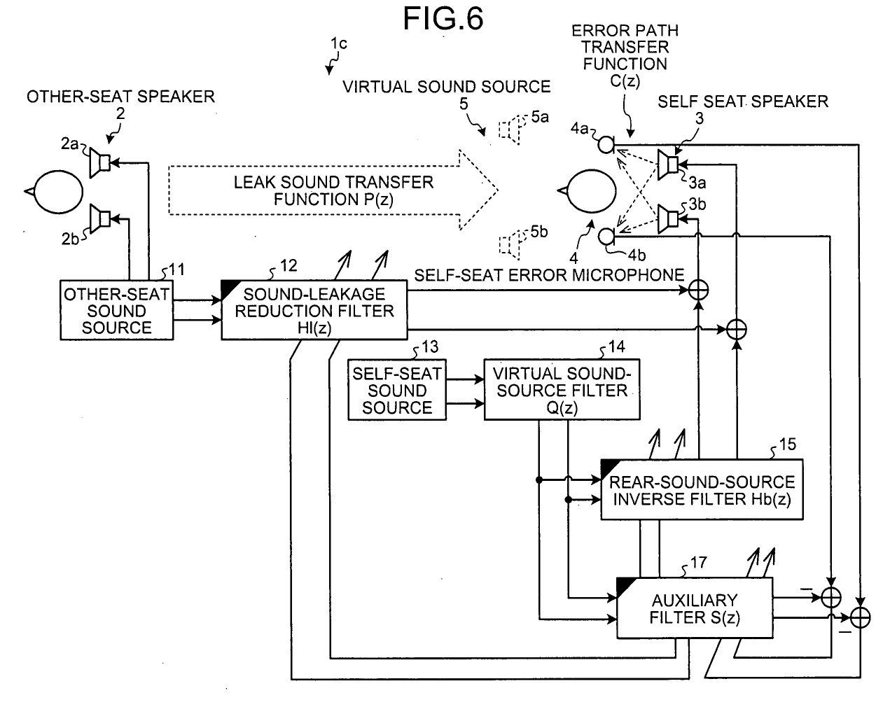

FIG. 6 is a schematic diagram of a configuration of the acoustic system according to the second embodiment. As illustrated in FIG. 6, an acoustic system 1c includes the other-seat speaker 2, the self seat speaker 3, the self-seat error microphone 4, the other-seat sound source 11, the sound-leakage reduction filter 12, the self-seat sound source 13, the virtual sound-source filter 14, the rear-sound-source inverse filter 15, and an auxiliary filter 17. The sound provided from the self seat speaker 3 has a virtual sound image in front of the listener on the self seat (see “virtual sound source 5” in FIG. 6). Filters indicated in black at an upper left corner (the sound-leakage reduction filter 12, the rear-sound-source inverse filter 15, and the auxiliary filter 17) express that these filters are ADFs (adaptive digital filters).

As illustrated in FIG. 6, the acoustic system 1c according to the second embodiment dynamically presumes the leak sound transfer function P(z) between the other-seat speaker 2 and the self-seat error microphone 4 and the error path transfer function C(z) between the self seat speaker 3 and the self-seat error microphone 4 to effectively reduce the sound leaked from the other-seat speaker 2 to the listener on the self seat, and localizes the sound generated from the self seat speaker 3 in front of the listener as indicated by the virtual sound source 5, to provide an individual acoustic environment with a realistic sense.

Thus, by providing the error transfer function C(z) dynamically presumed by the auxiliary filter 17 to the rear-sound-source inverse filter 15, and by providing the leak sound transfer function P(z) and the error transfer function C(z)) dynamically presumed to the sound-leakage reduction filter 12, the accuracy of the sound-leakage reduction filter 12 and the rear-sound-source inverse filter 15 can be improved. Because the sound-leakage reduction filter 12 and the rear-sound-source inverse filter 15 are adaptively controlled by using one auxiliary filter (auxiliary filter 17), the amount of calculation can be reduced as compared with a case that a plurality of auxiliary filters are used.

The second embodiment is the same as in the first embodiment in a feature that a sound having a sound image in front of the listener is generated by the virtual sound-source filter 14, and the sound image based on the position of the self seat speaker 3 is localized at a position of the self-seat error microphone 4 near the ear position of the listener by the rear-sound-source inverse filter 15.

The other-seat speaker 2, the self seat speaker 3, the self-seat error microphone 4, and the virtual sound source 5 are the same as those in the first embodiment. The other-seat sound source 11 and the self-seat sound source 13 are also the same as those in the first embodiment. However, the second embodiment is different from the first embodiment in that the auxiliary filter 16 according to the first embodiment receives the signal from the other-seat sound source 11, whereas the auxiliary filter 17 according to the second embodiment receives the signal from the self-seat sound source 13 via the virtual sound-source filter 14.

The sound-leakage reduction filter 12 uses the leak sound transfer function P(z) and the error path transfer function C(z) presumed based on the output of the auxiliary filter 17, to generate a control sound for negating the leak sound from the other-seat speaker 2 on the front seat. A feature that the sound-leakage reduction filter 12 is configured as the ADF (adaptive digital filter), and the calculation procedure of the sound-leakage reduction filter 12 are the same as those in the first embodiment.

The virtual sound-source filter 14 is a filter (Q(z)) that receives the output from the self-seat sound source 13 to generate the virtual sound field having the virtual sound image in front of the listener on the self seat. The virtual sound field generated by the virtual sound-source filter 14 is obtained, as indicated by the virtual sound source 5 in FIG. 1, by processing a signal from the self-seat sound source 13 as if there is a sound source in front of the listener. The virtual sound-source filter 14 can obtain a sound field with a realistic sense and without exerting a processing load, because the transfer function is obtained in advance based on a preliminary measurement result.

The rear-sound-source inverse filter 15 is a filter corresponding to the inverse function of the error path transfer function C(z) between the self seat speaker 3 and the self-seat error microphone 4, and performs a process of localizing the virtual sound field based on the position of the self seat speaker 3 at a position of the self-seat error microphone 4. Accordingly, rearward localization of the sound image resulting from installation of the self seat speaker 3 at the back of the listener can be corrected. When the rear-sound-source inverse filter 15 is designated as “Hb(z)”, Hb(z) is expressed by the equation “Hb(z)=1/C(z)”. C(z) in this equation is dynamically presumed by the auxiliary filter 17.

The auxiliary filter 17 receives outputs from the virtual sound-source filter 14 and the self-seat error microphone 4, and performs a process of presuming the leak sound transfer function P(z) and the error path transfer function C(z). The output of the auxiliary filter 16 is used for the adaptive control of the sound-leakage reduction filter 12 and the rear-sound-source inverse filter 15.

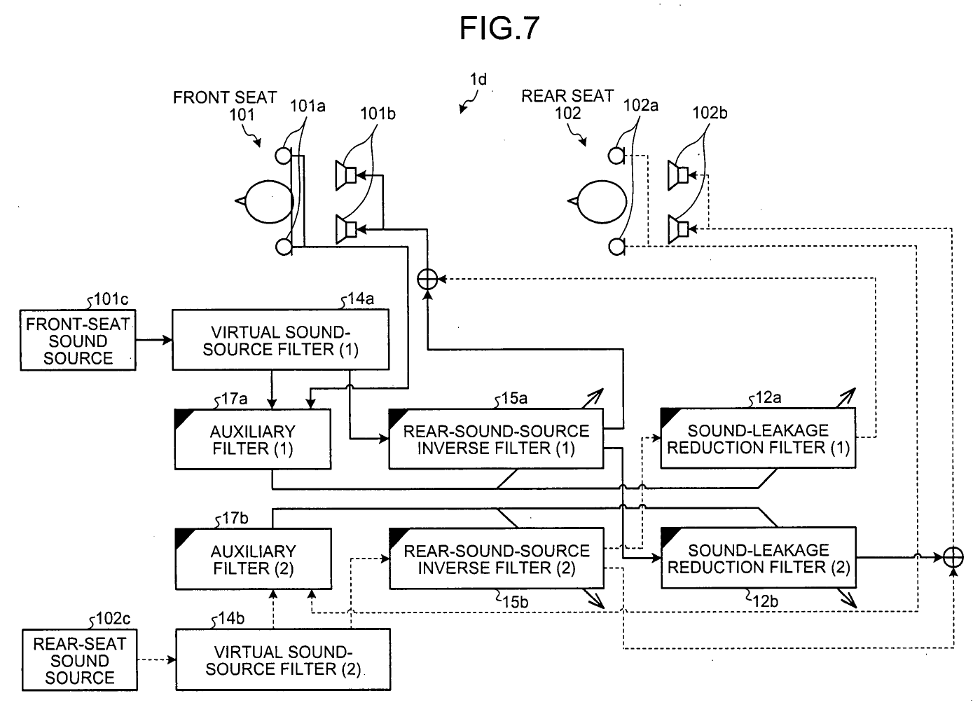

With reference to FIG. 7, a description will be given of a configuration of an acoustic system 1d as the acoustic system 1c of the second embodiment applied to a plurality of seats. FIG. 7 is a schematic diagram of a configuration of the acoustic system 1c of the second embodiment applied to a plurality of seats. In FIG. 7, the “other seat” in FIG. 6 is referred to as the “front seat”, and the “self seat” is referred to as the “rear seat”. The other-seat sound source 11 in FIG. 6 is described as the front-seat sound source 101c, and the self-seat sound source 13 is described as the rear-seat sound source 102c.

As illustrated in FIG. 7, the acoustic system 1d includes two sets of the sound-leakage reduction filters 12, the virtual sound-source filters 14, the rear-sound-source inverse filters 15, and the auxiliary filters 17 illustrated in FIG. 6. The front-seat error microphone 101a and the front seat speaker 101b are provided to the front seat 101, and the rear-seat error microphone 102a and the rear seat speaker 102b are provided to the rear seat 102. The front-seat sound source 101c is prepared as a sound source corresponding to the front seat 101, and the rear-seat sound source 102c is prepared as a sound source corresponding to the rear seat 102. Further, as illustrated in FIG. 7, the error microphone and the speaker are installed at each seat.

In the acoustic system 1c illustrated in FIG. 6, because provision of the virtual sound source and localization control processing with respect to the other seat are omitted, the other-seat sound source 11 is directly connected to the other-seat speaker 2. However, in the acoustic system 1d illustrated in FIG. 7, provision of the virtual sound source and the localization control processing are performed with respect to each seat. Therefore, the front-seat sound source 110c is connected to the front seat speaker 101b via the virtual sound-source filter 14a and the rear-sound-source inverse filter 15a. Likewise, the rear-seat sound source 102c is connected to the rear seat speaker 102b via the virtual sound-source filter 14b and the rear-sound-source inverse filter 15b.

As illustrated in FIG. 7, an auxiliary filter 17a (auxiliary filter (1) in FIG. 7) is connected to the virtual sound-source filter 14a (virtual sound-source filter (1) in FIG. 7) and the front-seat error microphone 101a to adaptively control the rear-sound-source inverse filter 15a (rear-sound-source inverse filter (1) in FIG. 7) and the sound-leakage reduction filter 12a (rear-sound-source inverse filter (1) in FIG. 7). Further, an auxiliary filter 17b (auxiliary filter (2) in FIG. 7) is connected to the virtual sound-source filter 14b (virtual sound-source filter (2) in FIG. 7) and the rear-seat error microphone 102a to adaptively control the rear-sound-source inverse filter 15b (rear-sound-source inverse filter (2) in FIG. 7) and the sound-leakage reduction filter 12b (rear-sound-source inverse filter (2) in FIG. 7).

Sound-leakage reduction control with respect to the rear seat 102 is performed in a procedure described below. That is, a signal from the front-seat sound source 101c passes through the virtual sound-source filter 14a (virtual sound-source filter (1)), and is distributed to the auxiliary filter 17a (auxiliary filter (1)) and the rear-sound-source inverse filter 15a (rear-sound-source inverse filter (1)). The signal from the rear-sound-source inverse filter 15a (rear-sound-source inverse filter (1)) is input to the front seat speaker 101b and the sound-leakage reduction filter 12b (sound-leakage reduction filter (2)).

On the other hand, the auxiliary filter 17b (auxiliary filter (2)) dynamically presumes the error path transfer function between the rear-seat error microphone 102a and the rear seat speaker 102b, and the leak sound transfer function between the rear-seat error microphone 102a and the front seat speaker 101b, and provides the dynamically presumed error path transfer function and leak sound transfer function to the sound-leakage reduction filter 12b (sound-leakage reduction filter (2)). The sound-leakage reduction filter 12b (sound-leakage reduction filter (2)) outputs to the rear seat speaker 102b a control sound for negating a sound leaked from the front seat speaker 101b.

Localization control with respect to the rear seat 102 is performed in a procedure described below. That is, the error path transfer function dynamically presumed by the auxiliary filter 17b (auxiliary filter (2)) is provided to the rear-sound-source inverse filter 15b (rear-sound-source inverse filter (2)), and the rear-sound-source inverse filter 15b (rear-sound-source inverse filter (2)) performs a process of localizing a signal from the virtual sound-source filter 14b (virtual sound-source filter (2)) forward and outputs the signal to the rear seat speaker 102b.

Meanwhile, sound-leakage reduction control with respect to the front seat 101 is performed in a procedure described below. That is, a signal from the rear-seat sound source 102c passes through the virtual sound-source filter 14b (virtual sound-source filter (2)), and is distributed to the auxiliary filter 17b (auxiliary filter (2)) and the rear-sound-source inverse filter 15b (rear-sound-source inverse filter (2)). The signal from the rear-sound-source inverse filter 15b (rear-sound-source inverse filter (2)) is input to the rear seat speaker 102b and the sound-leakage reduction filter 12a (sound-leakage reduction filter (2)).

Meanwhile, the auxiliary filter 16a (auxiliary filter (1)) dynamically presumes the error path transfer function between the front-seat error microphone 101a and the front seat speaker 101b, and the leak sound transfer function between the front-seat error microphone 101a and the rear seat speaker 102b, and provides the dynamically presumed error path transfer function and leak sound transfer function to the sound-leakage reduction filter 12a (sound-leakage reduction filter (1)). The sound-leakage reduction filter 12a (sound-leakage reduction filter (1)) outputs to the front seat speaker 101b a control sound for negating a sound leaked from the rear seat speaker 102b.

Further, localization control with respect to the front seat 101 is performed in a procedure described below. That is, the error path transfer function dynamically presumed by the auxiliary filter 17a (auxiliary filter (1)) is provided to the rear-sound-source inverse filter 15a (rear-sound-source inverse filter (1)), and the rear-sound-source inverse filter 15a (rear-sound-source inverse filter (1)) performs a process of localizing a signal from the virtual sound-source filter 14a (virtual sound-source filter (1)) forward and outputs the signal to the front seat speaker 101b.

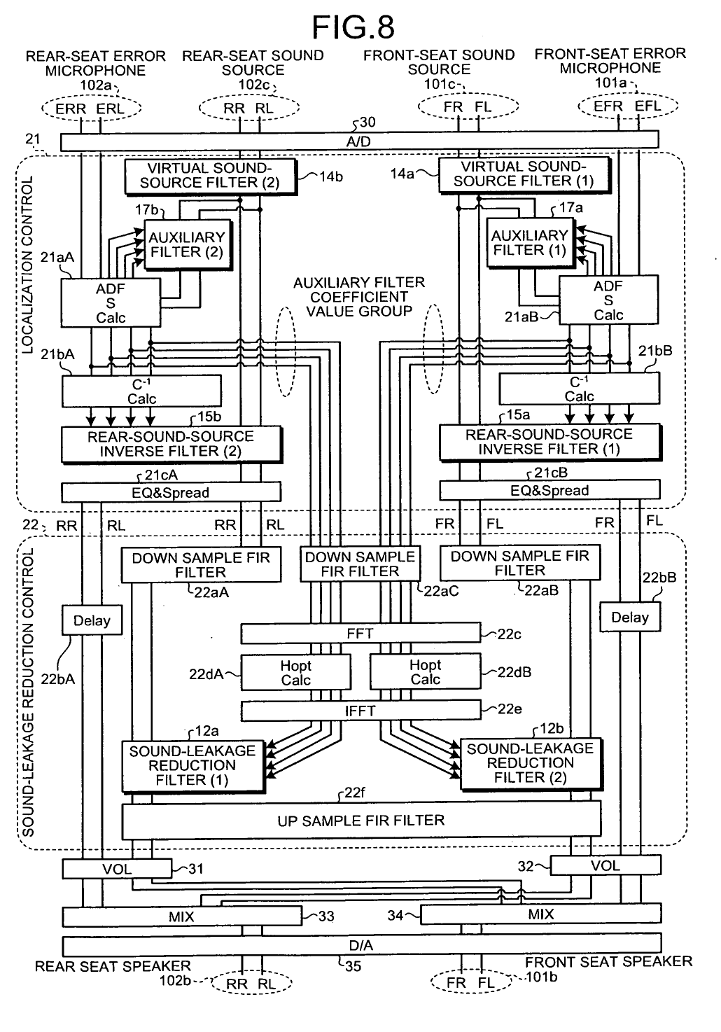

A signal flow in the acoustic system 1d illustrated in FIG. 7 is explained next with reference to FIG. 8. FIG. 8 depicts a signal flow in the acoustic system 1d according to the second embodiment. In FIG. 8, “A/D 30” stands for analog-to-digital converter, “EQ and Spread 21cA” and “EQ and Spread 21cB” denote distributor and equalizer, “FFT 22c” stands for Fast Fourier Transform, “IFFT 21e” stands for inverse Fast Fourier Transform, “VOL 31” and “VOL 32” stand for volume, “MIX 33” and “MIX 34” stand for mixer, and “D/A 35” stands for digital-to-analog converter.

Further, regarding the rear-seat error microphone 102a, the right signal is described as “ERR” and the left signal is described as “ERL”, and regarding the rear seat speaker 102b, the right signal is described as “RR” and the left signal is described as “RL”. Regarding the front-seat error microphone 101a, the right signal is described as “EFR” and the left signal is described as “EFL”, and regarding the front seat speaker 101b, the right signal is described as “FR” and the left signal is described as “FL”.

As illustrated in FIG. 8, control processing performed by the acoustic system 1d can be divided into the localization control 21 mainly performed by the virtual sound-source filter 14 (see 14a and 14b in FIG. 8) and the rear-sound-source inverse filter 15 (see 15a and 15b in FIG. 8), and the sound-leakage reduction control 22 mainly performed by the auxiliary filter 17 (see 17a and 17b in FIG. 8) and the sound-leakage reduction filter 12 (see 12a and 12b in FIG. 5).

A signal flow in the localization control 21 is explained first. The signals RR and RL corresponding to the rear-seat sound source 102c are input to the virtual sound-source filter 14b (virtual sound-source filter (2)) via the A/D 30. The virtual sound-source filter 14b (virtual sound-source filter (2)) converts the signals RR and RL to signals corresponding to the virtual sound field having a virtual sound image in front of the listener on the rear seat, and outputs the signals to the rear-sound-source inverse filter 15b (rear-sound-source inverse filter (2)) and an ADF-S-Calc 21aA.

Further, the signals ERR and ERL corresponding to the rear-seat sound source 102a are input to an ADF-S-Calc 21aA. The ADF-S-Calc 21aA calculates S(z), which is a value of the auxiliary filter 17b (auxiliary filter (2)). The ADF-S-Calc 21aA outputs the error path transfer function C(z) between the rear-seat error microphone 102a and the rear seat speaker 102b dynamically presumed to a C⁻¹ Calc 21bA, and also outputs the error path transfer function C(z) between the rear-seat error microphone 102a and the rear seat speaker 102b and the leak sound transfer function P(z) between the rear-seat error microphone 102a and the front seat speaker 101b dynamically presumed toward the sound-leakage reduction filter 12b (sound-leakage reduction filter (2)). The rear-sound-source inverse filter 15b (rear-sound-source inverse filter (2)) having received the output from the C⁻¹ Calc 21bA outputs to the EQ and Spread 21cA the signals RR and RL having subjected to a correction process of bringing the rearward localization of the sound image closer to the ear position of the listener.

Meanwhile, the signals FR and FL corresponding to the front-seat sound source 101c are input to the virtual sound-source filter 14a (virtual sound-source filter (1)) via the A/D 30. The virtual sound-source filter 14a (virtual sound-source filter (1)) converts the signals RR and RL to signals corresponding to the virtual sound field having a virtual sound image in front of the listener on the front seat, and outputs the signals to the rear-sound-source inverse filter 15a (rear-sound-source inverse filter (1)) and an ADF-S-Calc 21aB.

Further, the signals EFR and EFL corresponding to the front-seat error microphone 101a are input to the ADF-S-Calc 21aB. The ADF-S-Calc 21aB calculates S(z), which is the value of the auxiliary filter 17a (auxiliary filter (1)). The ADF-S-Calc 21aB outputs the error path transfer function C(z) between the front-seat error microphone 101a and the front seat speaker 101b dynamically presumed to a C⁻¹ Calc 21bB, and also outputs the error path transfer function C(z) between the front-seat error microphone 101a and the front seat speaker 101b and the leak sound transfer function P(z) between the front-seat error microphone 101a and the rear seat speaker 102b dynamically presumed toward the sound-leakage reduction filter 12a (sound-leakage reduction filter (1)). The rear-sound-source inverse filter 15a (rear-sound-source inverse filter (1)) having received the output from the C⁻¹ Calc 21bB outputs to the EQ and Spread 21cB the signals RR and RL having subjected to the correction process of bringing the rearward localization of the sound image closer to the ear position of the listener.

A signal flow in the sound-leakage reduction control 22 is explained next. The signals RR and RL distributed by the EQ and Spread 21cA are input to the Delay 22bA and the Down Sample FIR filter 22aA. The Delay 22bA having received the distributed signals RR and RL performs a predetermined delay process with respect to these signals, and outputs the signals to the rear-seat speaker 102b via the VOL 31, the MIX 33, and the D/A 35 as signals RR and RL.

The Down Sample FIR filter 22aA having received the distributed signals RR and RL performs resampling (down-sampling) by using a sampling frequency lower than the sampling frequency of the input signals. The signals down-sampled by the Down Sample FIR filter 22aA are up-sampled in the Up Sample FIR filter 22f and output. Thus, by using the down-sampling and the up-sampling together, the leak sound can be reduced highly accurately compared with a case that only the sound in the predetermined frequency range is reduced by using a low-pass filter or the like.

The signals RR and RL output from the Down Sample FIR filter 22aA are input to the sound-leakage reduction filter 12a sound-leakage reduction filter (1)). Further, the signals from the ADF-S-Calc 21aA are input to the sound-leakage reduction filter 12a (sound-leakage reduction filter (1)) via the Down Sample FIR filter 22aC, the FFT 22c, a Hopt Calc 22dA, and the IFFT 22e. The control sound (negating sound of the leak sound) calculated by the sound-leakage reduction filter 12a (sound-leakage reduction filter (1)) is output to the MIX 34 via the Up Sample FIR filter 22f and the VOL 31, synthesized with the signals FR and FL converted in the localization control 21 by the MIX 34, and output to the front seat speaker 101b via the D/A 35 as the signals FR and FL.

Meanwhile, the signals FR and FL distributed by the EQ and Spread 21cB are input to the Delay 22bB and the Down Sample FIR filter 22aB. The Delay 22bB having received the distributed signals FR and FL performs a predetermined delay process with respect to these signals, and outputs the signals to the front seat speaker 101b via the VOL 32, the MIX 34, and the D/A 35 as signals FR and FL.

Further, the Down Sample FIR filter 22aB having received the distributed signals FR and FL performs resampling (down-sampling) by using a sampling frequency lower than the sampling frequency of the input signals. The signals down-sampled by the Down Sample FIR filter 22aB are up-sampled in the Up Sample FIR filter 22f and output. Thus, by using the down-sampling and the up-sampling together, the leak sound can be reduced highly accurately, as compared with a case that only a sound in a predetermined frequency range is reduced by using a low-pass filter or the like.

The signals FR and FL output from the Down Sample FIR filter 22aB are input to the sound-leakage reduction filter 12b (sound-leakage reduction filter (2)). The signals from the ADF-S-Calc 21aB are input to the sound-leakage reduction filter 12b (sound-leakage reduction filter (2)) via the Down Sample FIR filter 22aC, the FFT 22c, a Hopt Calc 22dB, and the IFFT 22e. The control sound (negating sound of the leak sound) calculated by the sound-leakage reduction filter 12b (sound-leakage reduction filter (2)) is output to the MIX 33 via the Up Sample FIR filter 22f and the VOL 32, synthesized with the signals FR and FL converted in the localization control 21 by the MIX 33, and output to the rear seat speaker 102b via the D/A 35 as the signals FR and FL.

As described above, according to the second embodiment, at the time of providing the dynamically presumed leak sound transfer function and error path transfer function to the sound-leakage reduction filter, the auxiliary filter also provides the error path transfer function to the rear-sound-source inverse filter. Therefore, even if there is an environmental change and a change with time, leak sound from other seats can be effectively reduced, and an individual acoustic environment can be provided with a realistic sense while not blocking the visibility of the listener.

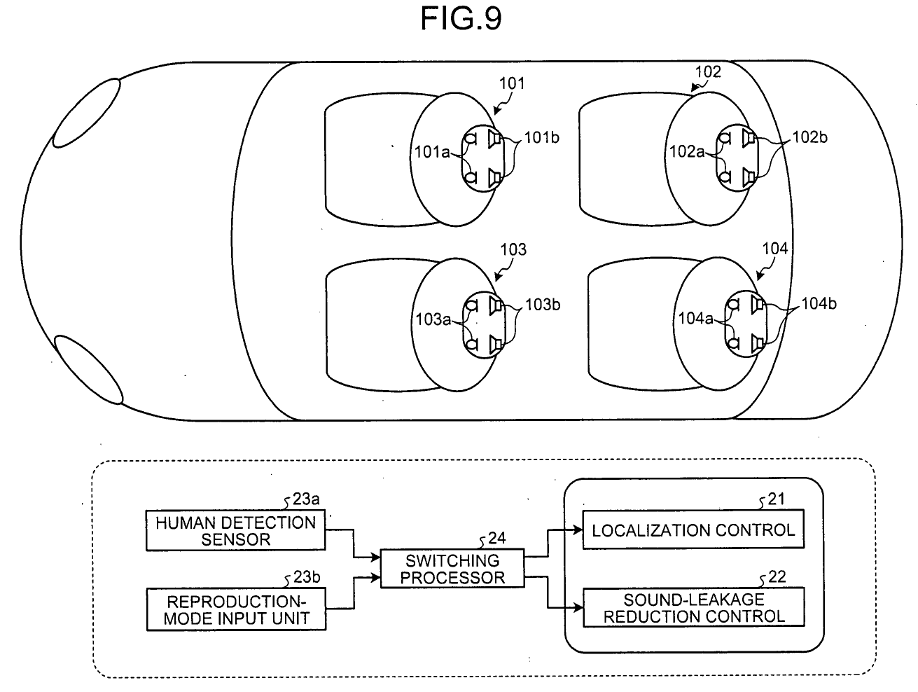

By adding a unit that changes a mode of the acoustic environment (individual acoustic environment/identical acoustic environment) to be provided to each seat or by adding a storage unit that stores the calculation result of the respective filters with respect to the first and second embodiments, the convenience of the listener can be improved and the processing load to the respective filters can be reduced without degrading the quality of the individual acoustic environment. Such a modified example is explained next with reference to FIG. 9.

FIG. 9 depicts a switching process of the localization control and the sound-leakage reduction control. As explained with reference to FIG. 5 or 8, the acoustic system according to the present invention combines the localization processing for localizing the sound image output from the speaker installed at the back of each listener to the front of each listener and the sound-leakage reduction control for reducing the leak sound from the other seats. However, it may not be always necessary that both of the localization control and the sound-leakage reduction control function in each individual space.

For example, when the same music or voice is enjoyed in each individual space, the localization control needs only to function, and the sound-leakage reduction control is not used. When a specific listener does not listen to the music or voice, but feels uneasy about the leak sound from other seats, the sound-leakage reduction control needs only to function.

As illustrated in FIG. 9, it is assumed that the error microphones (101a to 104a in FIG. 9) and the speakers (see 101b to 104b in FIG. 9) are installed on the respective seats in the car (see 101 to 104 in FIG. 9), and the localization control 21 and the sound-leakage reduction control 22 can be provided to the respective seats.

A human detection sensor 23a detects whether a listener seats on each seat. The human detection sensor 23a can be formed of a pressure sensor or the like installed on the seat. The presence of the listener can be determined by a combination with a device that captures images of each seat.

A reproduction-mode input unit 23b inputs the mode of the acoustic environment to be provided to the respective seats. For example, the reproduction-mode input unit 23b can select an identical acoustic environment mode in which all the sound sources to be provided to the front seats are identical and an individual acoustic environment mode in which the sound sources to be provided to the respective seats are different. When the sound source selected by each listener is different from each other as a result, the individual acoustic environment mode can be automatically selected. When the sound source selected by each listener is the same as a result, the identical acoustic environment mode can be automatically selected.

A switching processor 24 receives a signal from the human detection sensor 23a and the reproduction-mode input unit 23b to control operation start and suspension of the localization control 21 or the sound-leakage reduction control 22. For example, when the human detection sensor 23a detects listeners in 101 and 102 in FIG. 9 and the individual acoustic environment mode is selected by the reproduction-mode input unit 23b, the switching processor 24 runs the localization control 21 and the sound-leakage reduction control 22 in 101 and 102 in FIG. 9, and suspends the operation of the localization control 21 and the sound-leakage reduction control 22 in 103 and 104 in FIG. 9.

When the human detection sensor 23a detects listeners in 101 and 102 in FIG. 9 but the identical acoustic environment mode is selected by the reproduction-mode input unit 23b, the switching processor 24 suspends the operation of the sound-leakage reduction control 22 in 101 and 102 in FIG. 9 and runs the localization control 21. When the individual acoustic environment mode is selected by the reproduction-mode input unit 23b but the human sensor 23a detects only a listener in 101 in FIG. 9, the switching processor 24 runs the localization control 21 only in 101 in FIG. 9 and suspends the sound-leakage reduction control 22 on all the seats.

Thus, by running or suspending the localization control 21 or the sound-leakage reduction control 22 individually corresponding to the presence or preference of the listener on each seat, the convenience of the listener can be improved and the processing load due to the operation of the respective filters can be reduced.

As illustrated in FIG. 9, when the function of the localization control 21 or the sound-leakage reduction control 22 with respect to the respective seats is suspended and the operation is restarted after suspension for a predetermined period, a given amount of calculation processing is required until the operation of the localization control 21 or the sound-leakage reduction control 22 becomes stable and a sufficient effect is demonstrated. This is because the auxiliary filter 16 or the auxiliary filter 17 presumes the respective transfer functions based on a predetermined initial value. Therefore, if a filter coefficient at the time of suspending the respective filters is stored in a storage unit such as a memory, and when the operation of the respective filters is restarted, calculation is restarted using the filter coefficient stored in the storage unit as the initial value, the processing load at the time of restarting the operation can be reduced, and the time until the operation of the respective filters is stabilized can be reduced.

Further, when there is no fluctuation for the value of the auxiliary filter 16 or 17 for a certain period of time, the adaptive control with respect to the sound-leakage reduction filter 12 or the rear-sound-source inverse filter 15 can be stopped to perform fixed value control. Accordingly, the processing load due to the calculation processing can be reduced. The auxiliary filter 16 or 17 holds the value at a step immediately before a present step in certain time and calculates a difference between the present step and the previous step. Therefore, when there is no fluctuation in the value, the difference thereof becomes 0, and therefore the presence of fluctuation can be easily determined.

Further, when the operation of a specific filter is suspended, because the calculation processing load in the entire acoustic system is reduced, a margin thereof can be allocated to other filters. For example, the number of bits allocated to calculation of other filters can be increased or the number of calculation per hour can be increased.

Therefore, the sound-leakage reduction filter generates a control sound for negating the sound leaked from the other speaker installed in the second individual space toward the first individual space based on the leak sound transfer function between the other speaker and the error microphone and the error path transfer function between the self speaker and the error microphone, by using the self speaker installed at the back of the listener in the first individual space and the error microphone installed closer to the listener than the self speaker, and provides the generated control sound to the self speaker. The virtual sound-source filter generates a virtual sound source, which is a sound provided by arranging a sound image in front of the listener, and the rear-sound-source inverse filter corrects the rearward localization of the sound image generated by reproduction of the virtual sound source by the self speaker closer to the listener. The auxiliary filter connected to the sound-leakage reduction filter and the rear-sound-source inverse filter provides the error microphone, the leak sound transfer function and the error path transfer function presumed dynamically to the sound-leakage reduction filter, and the error path transfer function presumed dynamically to the rear-sound-source inverse filter. Therefore, even if there is an environmental change and a change with time, leak sound from other seats can be effectively reduced, and an individual acoustic environment can be provided with a realistic sense while not blocking the visibility of the listener.

As described above, the acoustic system according to the present invention is useful for providing an individual acoustic environment with respect to each individual space provided in a predetermined space, and particularly suitable for providing an individual acoustic environment in a movable vehicle such as a car.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An acoustic system comprising:
a self speaker that is installed to be located at back of a listener in a first individual space in a predetermined space;
an error microphone that is installed to be located closer to the listener than the self speaker;
a sound-leakage reducing unit that generates control sound for negating sound leaked from an other speaker installed in a second individual space in the predetermined space to the first individual space based on a leak sound transfer function between the other speaker and the error microphone and an error path transfer function between the self speaker and the error microphone, and provides the control sound to the self speaker;
a virtual sound-source unit that generates a virtual sound source to form a sound image in front of the listener;
a localization correcting unit that corrects rearward localization of the sound image closer to the listener, the sound image being formed by reproduction of the virtual sound source by the self speaker; and
a dynamic presuming unit that is connected to the error microphone, the sound-leakage reducing unit, and the localization correcting unit, provides the leak sound transfer function and the error path transfer function presumed dynamically to the sound-leakage reducing unit, and provides the error path transfer function presumed dynamically to the localization correcting unit.

2. The acoustic system according to claim 1, wherein the dynamic presuming unit provides the error path transfer function to the localization correcting unit when providing the leak sound transfer function and the error path transfer function presumed dynamically to the sound-leakage reducing unit.

3. The acoustic system according to claim 1, wherein the dynamic presuming unit provides the error path transfer function and the leak sound transfer function presumed together with the error path transfer function to the sound-leakage reducing unit when providing the error path transfer function presumed dynamically to the localization correcting unit.

4. The acoustic system according to claim 1, further comprising a self speaker, an error microphone, a sound-leakage reducing unit, a localization correcting unit, and a dynamic presuming unit to allow the first individual space and the second individual space to be interchanged.

5. The acoustic system according to claim 2, further comprising a self speaker, an error microphone, a sound-leakage reducing unit, a localization correcting unit, and a dynamic presuming unit to allow the first individual space and the second individual space to be interchanged.

6. The acoustic system according to claim 3, further comprising a self speaker, an error microphone, a sound-leakage reducing unit, a localization correcting unit, and a dynamic presuming unit to allow the first individual space and the second individual space to be interchanged.

7. The acoustic system according to claim 4, further comprising a detecting unit that detects presence of a human in the first individual space and the second individual space, wherein
the sound-leakage reducing unit, the localization correcting unit, and the dynamic presuming unit operate for the individual space in which the detecting unit detects a human.

8. The acoustic system according to claim 4, further comprising a selecting unit that selects whether provision of individual acoustic environment is necessary for each individual space, wherein
the sound-leakage reducing unit, the localization correcting unit, and the dynamic presuming unit operate for the individual space to which the selecting unit selects that provision of individual acoustic environment is necessary.

9. The acoustic system according to claim 7, further comprising a selecting unit that selects whether provision of individual acoustic environment is necessary for each individual space, wherein
the sound-leakage reducing unit, the localization correcting unit, and the dynamic presuming unit operate for the individual space to which the selecting unit selects that provision of individual acoustic environment is necessary.

10. The acoustic system according to claim 8, wherein the localization correcting unit and the dynamic presuming unit operate for the individual space to which the selecting unit selects that provision of individual acoustic environment is unnecessary.

11. The acoustic system according to claim 8, wherein the selecting unit selects, for each individual space, whether to operate the sound-leakage reducing unit and whether to operate the localization correcting unit.

12. The acoustic system according to claim 10, wherein the selecting unit selects, for each individual space, whether to operate the sound-leakage reducing unit and whether to operate the localization correcting unit.

13. The acoustic system according to claim 8, further comprising a storage unit that stores, when the selecting unit switches provision of individual acoustic environment from necessary to unnecessary, an internal coefficient of the sound-leakage reducing unit upon switching, wherein
the sound-leakage reducing unit continues, when the selecting unit switches provision of individual acoustic environment from unnecessary to necessary, operation using the internal coefficient stored in the storage unit.

14. The acoustic system according to claim 10, further comprising a storage unit that stores, when the selecting unit switches provision of individual acoustic environment from necessary to unnecessary, an internal coefficient of the sound-leakage reducing unit upon switching, wherein the sound-leakage reducing unit continues, when the selecting unit switches provision of individual acoustic environment from unnecessary to necessary, operation using the internal coefficient stored in the storage unit.

15. The acoustic system according to claim 11, further comprising a storage unit that stores, when the selecting unit switches provision of individual acoustic environment from necessary to unnecessary, an internal coefficient of the sound-leakage reducing unit upon switching, wherein
the sound-leakage reducing unit continues, when the selecting unit switches provision of individual acoustic environment from unnecessary to necessary, operation using the internal coefficient stored in the storage unit.

16. The acoustic system according to claim 1, wherein the dynamic presuming unit suspends adaptive processing for the sound-leakage reducing unit or the localization correcting unit when variation in presumed leak sound transfer function or error path transfer function is below a predetermined value over a predetermined period.

17. The acoustic system according to claim 1, further comprising a calculation accuracy change unit that improves, when one or more of the sound-leakage reducing unit, the localization correcting unit, and the dynamic presuming unit suspend operation, calculation accuracy of the unit in operation.

18. The acoustic system according to claim 1, wherein the self speaker is arranged on a backside of a seat in the first individual space to be near a head of the listener.

19. The acoustic system according to claim 1, wherein the first individual space and the second individual space each are a space corresponding to any one of seats in a car.
